(19) United States
(12) Patent Application Publication
(10) Pub. No.: US 2007/0236644 A1
(43) Pub. Date: Oct. 11, 2007

(54) Mother liquid crystal panel having discontinuous sealant

(75) Inventors: Jia-Yi Wu, Miao-Li (TW); Kun-Hsing Hsiao, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/784,996

(22) Filed: Apr. 9, 2007

(30) Foreign Application Priority Data
Apr. 7, 2006 (TW) 95112483

(51) Int. Cl. G02F 1/1339

(52) U.S. Cl. 349/153

(57) ABSTRACT

An exemplary liquid crystal panel (11) includes a first mother substrate (210), a second mother substrate (220) opposite to the first mother substrate, sealant (230), and conductive adhesive (240). The sealant is discontinuously provided at the first mother substrate, thereby defining a plurality of gaps (232) in the sealant. The conductive adhesive is filled in the gaps. When the second mother substrate is attached onto the first mother substrate and pressed, only a minimal amount of conductive adhesive expands beyond the outer boundary of the sealant. Therefore a subsequent step of cutting or splitting the mother liquid crystal panel into liquid crystal panels is unencumbered by any unwanted collateral conductive adhesive bonding. Moreover, because the sizes of the portions of the conductive adhesive can be configured as desired, it is relatively easy to mix the metal beads in the sealant to prepare the conductive adhesive.

### FIELD OF THE INVENTION

The present invention relates to mother liquid crystal panels that are divided into individual liquid crystal panels for the manufacturing of liquid crystal displays (LCDs), and particularly to a mother liquid crystal panel having a discontinuous sealant applied thereon.

### GENERAL BACKGROUND

An LCD is capable of displaying a clear and sharp image through thousands or even millions of pixels that make up the complete image. The liquid crystal display has thus been applied to various electronic equipment in which messages or pictures need to be displayed, such as mobile phones and notebook computers. The liquid crystal display generally includes a liquid crystal panel for displaying images, and a backlight for illuminating the liquid crystal panel.

The liquid crystal panel generally includes a thin film transistor (TFT) substrate, a color filter (CF) substrate, and a liquid crystal layer sandwiched between the two substrates. A method of fabricating a plurality of liquid crystal panels in a batch generally includes: forming a plurality of TFT substrates as parts of a first mother substrate, forming a plurality of CF substrates as parts of a second mother substrate, applying sealant at a periphery of each of the TFT substrates, thereby defining a plurality of spaces; filling liquid crystal material in the spaces; attaching the second mother substrate onto the first mother substrate to form a mother liquid crystal panel; and cutting the mother liquid crystal panel into a plurality of individual liquid crystal panels.

Referring to FIG. 9 and FIG. 10, a typical mother liquid crystal panel 100 is shown. The mother liquid crystal panel 100 includes a first mother substrate 110, and a second mother substrate 120 opposite to the first mother substrate 110. The first mother substrate 110 includes a plurality of TFT substrates 111 incorporated therein and arranged in an array. The second mother substrate 120 includes a plurality of CF substrates 121 incorporated therein and arranged in an array. The CF substrates 121 correspond to the TFT substrates 111 respectively. The mother liquid crystal panel 100 further includes sealant 112 applied at a periphery of each of the TFT substrates 111. The sealant 112 of each TFT substrate 111 is used to accommodate liquid crystal material (not shown) therein. Further, the sealant 112 of all the TFT substrates 111 is used to adhere the first mother substrate 110 to the second mother substrate 120. The first mother substrate 101 further includes conductive adhesive 115 applied at a periphery of the sealant 112 of each of the TFT substrates 111. The conductive adhesive 115 is used to electrically connect electrodes of each TFT substrate 111 with electrodes of the corresponding CF substrate 121. Thereby, the two substrates 111, 121 have the same electrical potential once they are bonded together.

Referring to FIG. 11, liquid crystal material is dropped in the space of each TFT substrate 111 defined by the sealant 112. The second mother substrate 120 is loosely attached onto the first mother substrate 110 and then pressed. Thereby, the sealant 112 and the conductive adhesive 115 are compressed somewhat. The sealant is then cured by UV (ultraviolet) irradiation or heating. Cutting lines 130 are formed at outer surfaces of the first and second mother substrates 110, 120. Alternatively, shear lines are formed at these outer surfaces. Then the mother liquid crystal panel 100 is cut along the cutting lines 130. Alternatively, the mother liquid crystal panel 100 is split along the shear lines by applying shear force. However, whichever of the above methods is used, the conductive adhesive 115 is expanded in transverse directions when the two mother substrates 110, 120 are pressed together. Conductive adhesive 115 located where two adjacent liquid crystal panels abut each other is liable to spread across the cutting line 130 thereat, whereby the conductive adhesive 115 of the adjacent liquid crystal panels adheres together. When this happens, it can be problematic to accurately cut or split the mother liquid crystal panel 100.

One way to overcome the above-described problems is to reduce the amount of conductive adhesive 115 applied on the first mother substrate 110. If this is done, an amount of metal beads mixed in the conductive adhesive 115 needs to be increased in order to maintain good electrical conductivity of the conductive adhesive 115. However, it is difficult to properly mix the metal beads in this kind of conductive adhesive 115. Furthermore, the composition of this kind of conductive adhesive 115 makes the step of applying the conductive adhesive 115 on the first mother substrate 110 problematic.

Therefore, a new mother liquid crystal panel that can overcome the above-described problems is desired.

### SUMMARY

In one preferred embodiment, a mother liquid crystal panel includes a first mother substrate, a second mother substrate opposite to the first mother substrate, sealant, and conductive adhesive. The sealant is discontinuously provided at the first mother substrate, thereby defining a plurality of gaps in the sealant. The conductive adhesive is filled in the gaps.

Other novel features and advantages will become more apparent from the following detailed description when taken in conjunction with the accompanying drawings.

### BRIEF DESCRIPTION OF THE DRAWINGS

FIG. 1 is an exploded, isometric view of a mother liquid crystal panel according to a first embodiment of the present invention, the mother liquid crystal panel including a first mother substrate and a second mother substrate.

FIG. 2 is an isometric view of the first mother substrate of the mother liquid crystal panel of FIG. 1.

FIG. 3 is an enlarged, side cross-sectional view of the mother liquid crystal panel shown in FIG. 1, corresponding to line III-III thereof.

FIG. 4 is similar to FIG. 3, but showing the first and second mother substrates attached together.

FIG. 5 is an enlarged view of a circled portion V of FIG. 4.

FIG. 6 is similar to FIG. 2, but essentially showing a corresponding view in the case of a first mother substrate of a mother liquid crystal panel according to a second embodiment of the present invention.

FIG. 7 is similar to FIG. 2, but essentially showing a corresponding view in the case of a first mother substrate of a mother liquid crystal panel according to a third embodiment of the present invention.

FIG. 8 is similar to FIG. 2, but essentially showing a corresponding view in the case of a first mother substrate of a mother liquid crystal panel according to a fourth embodiment of the present invention.

FIG. 9 is an exploded, isometric view of a conventional mother liquid crystal panel, the mother liquid crystal panel including a first mother substrate and a second mother substrate.

FIG. 10 is an enlarged, side cross-sectional view of the mother liquid crystal panel shown in FIG. 9, corresponding to line X-X thereof.

FIG. 11 is similar to FIG. 10, but showing the first and second mother substrates attached together.

### DETAILED DESCRIPTION OF PREFERRED EMBODIMENTS

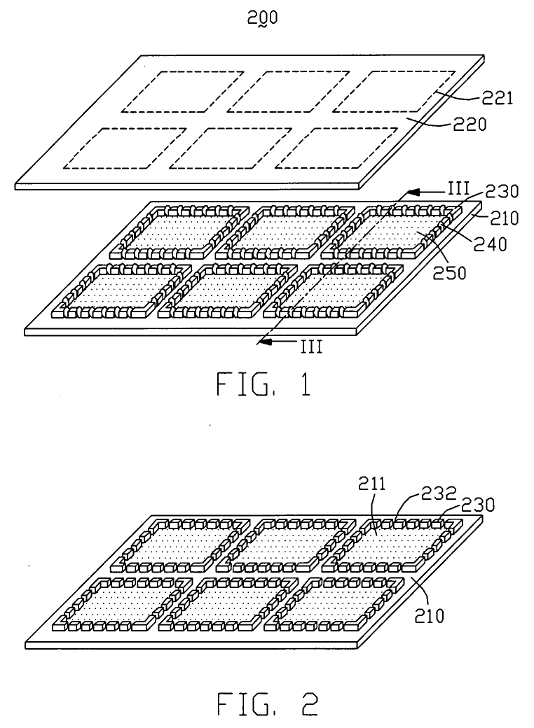

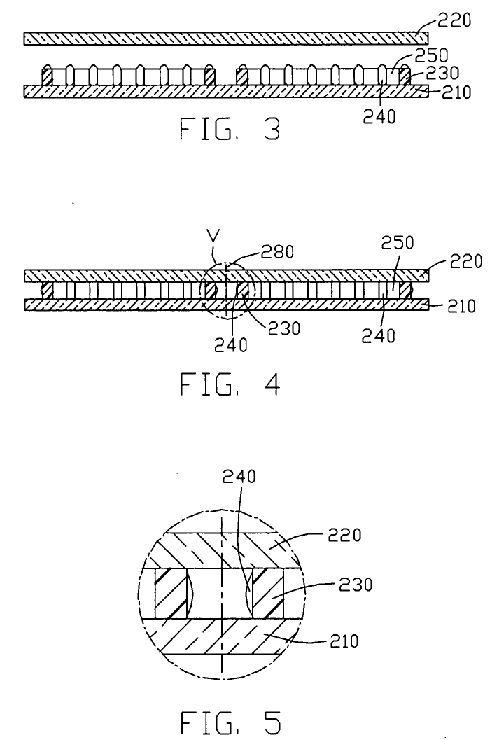

Referring to FIGS. 1, 2 and 3, aspects of a mother liquid crystal panel 200 according to a first embodiment of the present invention are shown. The mother liquid crystal panel 200 includes a first mother substrate 210, a second mother substrate 220, sealant 230, and conductive adhesive 240. The first mother substrate 210 and the second mother substrate 220 are oriented opposite to each other.

The first mother substrate 210 includes a plurality of TFT substrates 211 incorporated therein and arranged in an array. The second mother substrate 220 includes a plurality of CF substrates 221 incorporated therein and arranged in an array. The CF substrates 221 correspond to the TFT substrates 211, respectively. The sealant 230 is discontinuously applied on the first mother substrate 210 at a periphery of each of the TFT substrates 211. Thereby a plurality of gaps 232 is defined in the sealant 230. The sealant 230 of all the TFT substrates 211 is used to adhere the first mother substrate 210 to the second mother substrate 220. The conductive adhesive 240 is filled in the gaps 232, and is used to electrically connect electrodes of each TFT substrate 211 with electrodes of the corresponding CF substrate 221. Thereby, the two substrates 211, 221 have the same electrical potential once they are bonded together. Each TFT substrate 211 together with the sealant 230 and the conductive adhesive 240 provided thereat defines a space 250 for accommodating liquid crystal material (not shown).

The sealant 230 can be made from at least one material selected from the group consisting of ultraviolet-curable sealant and heat-curable sealant, such as epoxy. Typically, the conductive adhesive 240 is formed by mixing metal beads in a sealant such as an ultraviolet-curable sealant or a heat-curable sealant. The metal beads can be made from material including any one or more items selected from the group consisting of silver, copper, and aluminum.

A method for fabricating the mother liquid crystal panel 200 includes the following steps.

First, a first mother substrate 210 and a second mother substrate 220 are provided. The first mother substrate 210 includes a plurality of TFT substrates 211 formed as parts thereof. The second mother substrate 220 includes a plurality of CF substrates 221 formed as parts thereof.

Second, sealant 230 is discontinuously applied at a periphery of each of the TFT substrates 211, thereby defining a plurality of gaps 232.

Third, conductive adhesive 240 is filled in the gaps 232. Thereby, a space 250 is cooperatively defined by each of the TFT substrates 211, the corresponding sealant 230, and the corresponding conductive adhesive 240. A size of each portion of the conductive adhesive 240 can be configured by configuring sizes of the gaps 232 accordingly. In general, when the size of a portion of the conductive adhesive 240 is large, the amount of metal beads in the conductive adhesive 240 needs to be relatively small. Thereby, an appropriate uniform degree of electrical conductivity across all portions of the conductive adhesive 240 can be attained.

Fourth, referring also to FIGS. 4 and 5, liquid crystal material (not shown) is dropped into each of the spaces 250. The second mother substrate 220 is loosely attached onto the first mother substrate 210, and is pressed. Because the conductive adhesive 240 is filled in the gaps 232 and is not located at outer peripheries of the sealant 230 at each liquid crystal panel, little or no conductive adhesive 240 expands transversely beyond outer boundaries of the sealant 230. That is, the conductive adhesive 240 located where two adjacent liquid crystal panels abut each other is apt to not spread across from either of the liquid crystal panels to the other liquid crystal panel. Unlike in conventional art, the conductive adhesive 240 of each two adjacent liquid crystal panels avoids getting adhered together.

Fifth and finally, ultraviolet light or heat is used to cure the sealant 230.

Unlike with the above-described conventional mother liquid crystal panel 100, the conductive adhesive 240 filled in the gaps 232 of the sealant 230 of each TFT substrate 211 avoids spreading to an adjacent TFT substrate 211 when the second mother substrate 220 is attached onto the first mother substrate 210 and pressed. As shown in FIG. 5, typically, only a minimal amount of conductive adhesive 240 expands beyond the outer boundary of the corresponding sealant 230. Therefore a subsequent step of cutting or splitting (shearing) the mother liquid crystal panel 200 into the individual liquid crystal panels is unencumbered by any unwanted collateral conductive adhesive 240 bonding. Moreover, because the sizes of the portions of the conductive adhesive 240 can be configured as desired, it is relatively easy to mix the metal beads in the sealant to prepare the conductive adhesive 240, and it is relatively easy to fill the conductive adhesive 240 in the gaps 232.

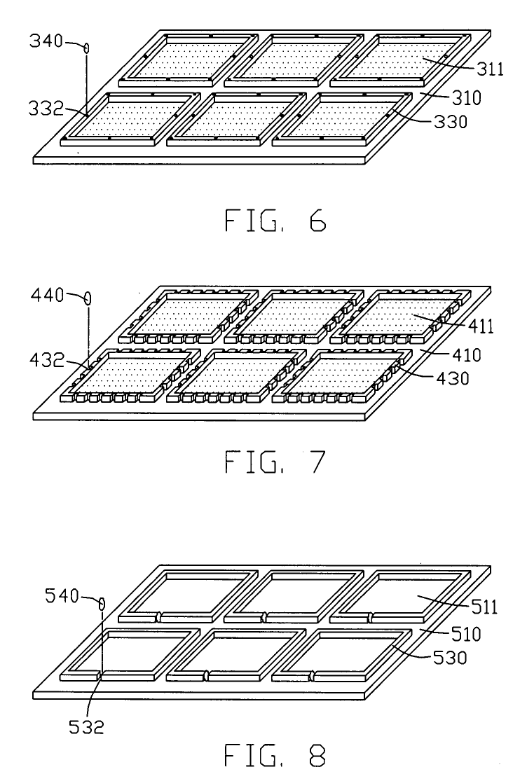

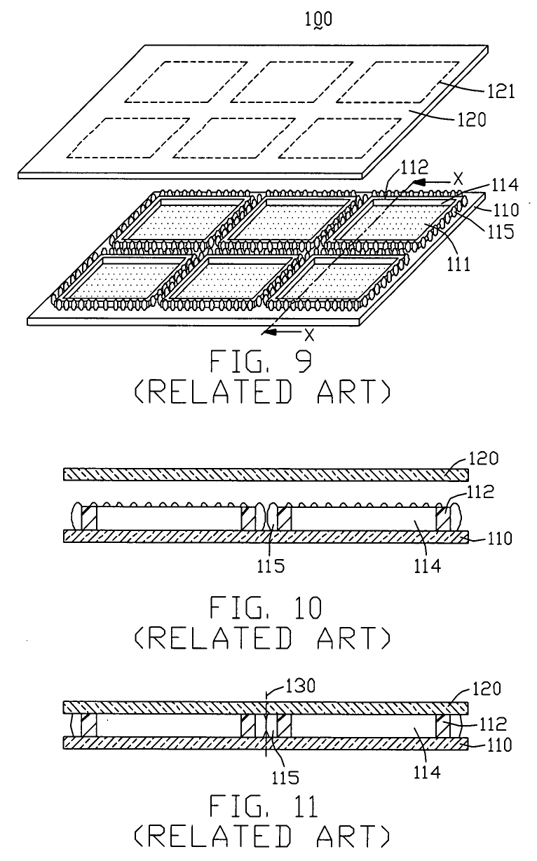

Further or alternative embodiments may include the following. In a second embodiment of the present invention, referring to FIG. 6, sealant 330 is continuously applied at a periphery of each of TFT substrates 311 of a first mother substrate 310. The sealant 330 has a plurality of vertical through holes 332 defined therein. Conductive adhesive 340 is filled in the through holes 332. In a third embodiment of the present invention, referring to FIG. 7, sealant 430 is continuously applied at a periphery of each of TFT substrates 411 of a first mother substrate 410. The sealant 330 has a plurality of cutouts 432 defined in an outer peripheral portion thereof. Conductive adhesive 440 is filled in the cutouts 432. In a fourth embodiment of the present invention, referring to FIG. 8, sealant 530 is applied at a periphery of each of TFT substrates 511 of a first mother substrate 510. The sealant 530 of each TFT substrate 511 includes one gap 532 therein. Conductive adhesive 540 is filled in the gap 532.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A mother liquid crystal panel comprising:
a first mother substrate;
a second mother substrate opposite to the first mother substrate; and
sealant discontinuously provided at the first mother substrate, thereby defining a plurality of gaps in the sealant; and
conductive adhesive filled in the gaps.

2. The mother liquid crystal panel as claimed in claim 1, wherein the first mother substrate comprises a plurality of thin film transistor substrates incorporated therein and arranged in an array, the second mother substrate comprises a plurality of color filter substrates incorporated therein and arranged in an array, and the plurality of color filter substrates corresponds to the plurality of thin film transistor substrates.

3. The mother liquid crystal panel as claimed in claim 2, wherein the sealant is discontinuously provided at a periphery of each of the thin film transistor substrates.

4. The mother liquid crystal panel as claimed in claim 3, wherein each of the thin film transistor substrates, the corresponding sealant provided thereat, and the corresponding conductive adhesive provided thereat cooperatively define a space for accommodating liquid crystal material.

5. The mother liquid crystal panel as claimed in claim 1, wherein the sealant is made from material including at least one of ultraviolet-curable sealant and heat-curable sealant.

6. The mother liquid crystal panel as claimed in claim 5, wherein the sealant is made from epoxy.

7. The mother liquid crystal panel as claimed in claim 1, wherein the conductive adhesive comprises ultraviolet-curable sealant and metal beads mixed in the ultraviolet-curable sealant.

8. The mother liquid crystal panel as claimed in claim 1, wherein the conductive adhesive comprises heat-curable sealant and metal beads mixed in the heat-curable sealant.

9. The mother liquid crystal panel as claimed in claim 8, wherein the metal beads are made from at least one material selected from the group consisting of silver, copper, and aluminum.

10. A mother liquid crystal panel comprising:
a first mother substrate;
a second mother substrate opposite to the first mother substrate; and
sealant continuously provided at the first mother substrate, the sealant comprising a plurality of accommodating spaces therein; and
conductive adhesive filled in the accommodating spaces.

11. The mother liquid crystal panel as claimed in claim 10, wherein the first mother substrate comprises a plurality of thin film transistor substrates incorporated therein and arranged in an array, the second mother substrate comprises a plurality of color filter substrates incorporated therein and arranged in an array, and the plurality of color filter substrates corresponds to the plurality of thin film transistor substrates

12. The mother liquid crystal panel as claimed in claim 10, wherein the sealant is continuously provided at a periphery of each of the thin film transistor substrates.

13. The mother liquid crystal panel as claimed in claim 12, wherein each of the thin film transistor substrates, the corresponding sealant provided thereat, and the corresponding conductive adhesive provided thereat cooperatively define a space for accommodating liquid crystal material.

14. The mother liquid crystal panel as claimed in claim 10, wherein the accommodating spaces are through holes perpendicular to the first and second mother substrates.

15. The mother liquid crystal panel as claimed in claim 10, wherein the accommodating spaces are cutouts at an outer periphery of the sealant.

16. The mother liquid crystal panel as claimed in claim 10, wherein the sealant is made from at least one material selected from the group consisting of ultraviolet-curable sealant and heat-curable sealant.

17. The mother liquid crystal panel as claimed in claim 16, wherein the sealant is made from epoxy.

18. The mother liquid crystal panel as claimed in claim 10, wherein the conductive adhesive comprises ultraviolet-curable sealant and metal beads mixed in the ultraviolet-curable sealant.

19. The mother liquid crystal panel as claimed in claim 10, wherein the conductive adhesive comprises heat-curable sealant and metal beads mixed in the heat-curable sealant.

20. The mother liquid crystal panel as claimed in claim 19, wherein the metal beads are made from at least one material selected from the group consisting of silver, copper, and aluminum.
